(19) United States
(12) Patent Application Publication
(10) Pub. No.: US 2022/0154754 A1
(43) Pub. Date: May 19, 2022

(54) Retaining Ring

(71) Applicant: SEEGER-ORBIS GmbH, Konigstein (DE)

(72) Inventors: Jan Steiger, Essenheim (DE); Stephan Hoelke, Bad Vilbel (DE)

(21) Appl. No.: 17/507,738

(22) Filed: Oct. 21, 2021

(30) Foreign Application Priority Data
Oct. 30, 2020 (DE) 102020006666.6

(51) Int. Cl. F16B 21/18

(52) U.S. Cl. CPC F16B 21/186

(57) ABSTRACT

A retaining ring having a base body which is circular except for an opening interrupting it, the opening interrupting the ring shape being bounded on a first side by an end face of a first end of the base body and on a second side, opposite the first side, by an end face of a second end of the base body, and a mounting hole being provided in the first end and a mounting hole being provided in the second end, at least one closed pocket being provided in the base body.

### FIELD OF INVENTION

The invention relates to a retaining ring with a base body which is circular except for an opening interrupting it. Furthermore, the invention relates to a shaft with a circumferential groove. Furthermore, the invention relates to a component with a bore and a groove running around in the bore.

### BACKGROUND

Retaining ring are known from the standards DIN 471 for shaft grooves and DIN 472 for bore grooves. There it is shown that the retaining ring is designed with a base body which is circular except for an opening interrupting it. The opening interrupting the circular shape is bounded on a first side by an end face of the first end of the base body, and is bounded on a second side opposite the first side by an end face of a second end of the base body.

A retaining ring can be designed as a snap ring. In such a case, there is usually no mounting hole provided in the first end and no mounting hole provided in the second end. In other embodiments, the retaining ring is configured to provide a mounting hole in the first end and a mounting hole in the second end. The mounting holes can be used to mount the ring using special pliers.

From U.S. Pat. No. 4,183,280 a retaining ring with a base body, which is circular except for an opening interrupting it, is known, wherein the opening interrupting the annular shape is bounded on a first side by the end face of the first end of the base body and on a second side opposite the first side by the end face of the second end of the base body, wherein a mounting hole is provided in the first end and a mounting hole is provided in the second end. In the retaining ring known from U.S. Pat. No. 4,183,280, several open pockets are provided on the inner edge of the base body. A comparable retaining ring is known from EP 0 019 361 A1. There are even open pockets on the outer edge of the base body.

A disadvantage of the retaining rings known from U.S. Pat. No. 4,183,280 and EP 0 019 361 A1 is that they are costly to manufacture.

Against this background, the invention was based on the task of creating a retaining ring that is simpler to manufacture.

### SUMMARY

This task was solved by the retaining ring according to embodiments of the disclosure, as well as by the shaft or the component according to embodiments of the disclosure.

The invention starts from the basic idea of providing the basic body with at least one closed pocket.

The invention thus allows retaining rings to be produced which have a constant cross-section on the inner surface and the outer surface of the base body. It becomes possible to preserve the natural edge of the pipe material, where the natural edge of the pipe material is understood to be, for example, the outer surface of the wire used to make the retaining ring. Further, the invention permits the design of retaining rings that do not have fractures or indentations on the inner edge and/or the outer edge of the ring. The retaining ring according to the invention has a higher stress fracture tolerance. The invention allows a special design of an embodiment of the invention, once worked out properly, to be used for both retaining rings for shaft grooves as well as for retaining rings for bore grooves.

In the following description, the term “pocket” is used to refer to the closed pocket to be provided in the base body according to the invention, or the closed pocket to be provided in the base body. Insofar as the term “bag” is used in the following, this thus referring to a closed bag. If, according to preferred embodiments, open pockets are also provided in addition to the (closed) pockets, these are explicitly described as “open pocket” in the following description.

The retaining ring according to the invention has a base body which is circular except for an opening interrupting it. In a preferred embodiment, the base body has a rectangular cross-section in at least one radially extending plane, preferably in many radially extending planes, more preferably in the majority of radially extending planes, and most preferably in all radially extending planes intersecting the base body. In a preferred embodiment, the base body has a round cross-section at least in one radially extending plane, preferably in many radially extending planes, in particular preferably in the majority of the radially extending planes and very particularly preferably in all radially extending planes intersecting the base body. In a preferred embodiment, the base body has a polygonal cross-section in at least one radially extending plane, preferably in many radially extending planes, particularly preferably in the majority of the radially extending planes, and most preferably in all radially extending planes intersecting the base body.

A radially extending plane is understood to be a plane that intersects the base body and runs perpendicular to the circumferential direction of the base body that the base body has in this intersection. A mathematical plane has an infinite extension. Therefore, a mathematical plane would regularly intersect the base body twice (namely, wherever the mathematical plane does not pass through the opening). To avoid misunderstandings, “radial plane” in the present description is understood to mean only that part of a mathematical plane which extends away from the center of the base body and thus only once through the base body.

The center point of a retaining ring, in a retaining ring in which the “remaining area” is understood to be the part of the base body that connects the first end to the second end and in which the outer edge of the remaining area is (partially) circular around a center point and the inner edge of the remaining area is (partially) circular around the same center point, is understood to be this center point.

The center of a retaining ring, in the case of a retaining ring in which the “remaining area” is understood to be the part of the base body that connects the first end with the second end, and in which the outer edge of the remaining area is (part)circular around a center point but the inner edge of the remaining area is not continuously (part)circular around the same center point, the center point is understood to be the center of the retaining ring about which the outer edge is (part)circular; these rings are usually bore rings (rings for bore grooves).

The center of a retaining ring, in the case of a retaining ring in which the “remaining area” is understood to be that part of the base body which connects the first end to the second end and in which the inner edge of the remaining area is (part)circular around a center point but the outer edge of the remaining area is not continuously (part)circular around the same center point, is understood to be the center point of the retaining ring around which the inner edge is (part)circular; these rings are usually shaft rings (rings for grooves on shafts).

In a preferred embodiment, the base body has in at least one radially extending plane, and preferably in many radially extending planes, especially preferably in the majority of the radially extending planes and optimally in all radially extending planes which intersect the base body, a radial width which is greater than the respective thickness of the base body in the same plane.

In a preferred embodiment, the radial width of the base body at the first end of the base body and/or the radial width of the base body at the second end of the base body is different from the radial width that the base body has in at least one radial plane in its remaining region, wherein the remaining region of the base body is understood to be the part of the base body that connects the first end to the second end. In a preferred embodiment, the radial width of the base body at the first end of the base body and/or the radial width of the base body at the second end of the base body is greater than the radial width that the base body has in at least one radial plane in its remaining region.

In a preferred embodiment, the radial width of the base body is the same in a plurality, preferably in a plurality, preferably in all radial planes intersecting the base body in the remaining region.

In a preferred embodiment, the radial width of the first end of the base body is the same in a plurality, preferably in a plurality, preferably in all radial planes intersecting the base body in the first end.

Preferably, a step is provided between the first end and the remaining portion of the base body. In a preferred embodiment, the radial width of the second end of the base body is the same in a plurality, preferably in a plurality, preferably in all radial planes intersecting the base body in the second end. Preferably, a step is provided between the second end and the remaining portion of the base body.

Furthermore, embodiments are possible in which the radial width of the base body is the same in all radial planes intersecting the base body and is thus also the same in the region of the first end and the second end as the radial width in the remaining region of the base body.

The description of the retaining ring according to the invention refers to the untensioned state of the retaining ring. The invention describes a retaining ring in the untensioned state.

The opening interrupting the ring shape is bounded on a first side by an end face of a first end of the base body. In a preferred embodiment, the end surface of the first end of the base body is a surface that extends in a plane, preferably a radial plane. However, embodiments are also possible in which a recess, for example a semicircular recess, is provided in the end face of the first end of the base body. The opening interrupting the annular shape is bounded on a second side by an end face of a second end of the base body. In a preferred embodiment, the end surface of the second end of the base body is a surface that extends in a plane, preferably a radial plane. However, embodiments are also possible in which a recess, for example a semicircular recess, is provided in the end face of the second end of the base body. Such recesses in the ends of the base body are sometimes used in retaining rings instead of mounting holes made in the respective end of the base body.

In a preferred embodiment, the plane in which the end face of the first end is located is at an angle to the plane in which the end face of the second end of the base body is located. In a preferred embodiment, the angle between the plane in which the end face of the first end is located and the plane in which the end face of the second end is located is less than 180°, more preferably less than 160°, most preferably less than 130°. In a preferred embodiment, the angle between the plane in which the end face of the first end is located and the plane in which the end face of the second end is greater than 5°, more preferably greater than 10°, most preferably greater than 20°.

In an alternative, also preferred embodiment, the plane in which the end face of the first end is located is parallel to the plane in which the end face of the second end of the base body is located.

The invention can be applied to retaining rings in which a mounting hole is provided in the first end and a mounting hole is provided in the second end. The invention of this basic type of retaining ring is described in claim 1. However, the invention can also be applied to such retaining rings in which no mounting hole is provided in the first end and likewise no mounting hole is provided in the second end. This basic type of retaining ring is described in the adjacent claim 2. In a preferred embodiment, a mounting hole is provided in the first end but not in the second end.

In a preferred embodiment, the respective mounting hole (to the extent provided in the respective embodiment) is designed as a round hole or as an elongated hole. In a preferred embodiment, all mounting holes that are present are identical in shape and/or size. However, embodiments are also conceivable in which an existing mounting hole is different in shape and/or size from another mounting hole.

In a preferred embodiment, the first end is designed with a projection that projects radially outward (for example, for the application of shaft grooves) or radially inward (for example, for the application of bore grooves) relative to the remaining area of the base body. In a preferred embodiment, a mounting hole of the retaining ring is made in this protrusion. In a preferred embodiment, the second end is designed with a projection that projects radially outward (for example, for the application of shaft grooves) or radially inward (for example, for the application of bore grooves) relative to the remaining area of the base body. In a preferred embodiment, a mounting hole of the retaining ring is made in this protrusion. A first end designed with a protrusion is often referred to in the industry as an “ear” or “tab.”

According to the invention, at least one pocket is provided in the base body. In a preferred embodiment, the base body has only one pocket, or only pockets, but no open pockets as known, for example, from U.S. Pat. No. 4,183,280 and EP 0 019 361 A1.

In a particularly preferred embodiment, the base body has three pockets, more preferably three or more pockets.

In a preferred embodiment, to the extent that the base body has only a single pocket, the single pocket or one pocket of the multiple pockets provided in the base body is implemented in the region of the base body that is opposite the opening. In a preferred embodiment, a pocket is arranged in the region between 125° and 235° when the center of the opening is taken as the 0° position.

A pocket is understood to be an opening in the base body. For retaining rings that have mounting holes and thus already have openings, a pocket is an additional opening to the mounting holes. A pocket is, in particular, an opening in the base body that completely penetrates the base body. In particular, a pocket is an opening in the base body leading from a first surface of the base body to a second surface opposite the first surface and facing away from the first surface. A pocket is in particular an opening in the base body with a cross-sectional shape that remains the same through the thickness of the base body. For example, if the pocket is circular in cross-section, in a preferred embodiment the cross-section of the pocket remains circular throughout the extent of the pocket through the main body. For example, if the pocket is elliptical in cross-section, in a preferred embodiment the cross-section of the pocket remains elliptical throughout the extent of the pocket through the base body. For example, if the pocket is arched in cross-section, in a preferred embodiment the cross-section of the pocket remains arched throughout the extent of the pocket through the main body. In a preferred embodiment, the pocket is free of other elements of the base body that protrude into the pocket.

In a preferred embodiment, the pocket is bounded by perimeter walls. The boundary walls can be flat walls, for example in the case of a rectangular pocket. The boundary walls can also be curved walls, for example in the case of an elliptical pocket or an arc-shaped pocket. In a preferred embodiment, the boundary walls extend perpendicular to a surface of the base body, preferably perpendicular to the surface of the base body into which the pocket opens, or from which the pocket leads in through the base body.

In a preferred embodiment, the retaining ring is mirror-symmetrical with respect to a plane passing centrally through the opening. A plane passing centrally through the opening is understood to be a plane perpendicular to a circumferential direction of the base body and equally spaced from the end faces bounding the opening and passing through the opening.

Embodiments are possible in which the pockets are regularly distributed over the base body. A regular distribution of pockets over the base body is understood to be a distribution in which the angle
between a line running radially and through the center of the surface of a first pocket
and a line extending radially and through the center of the surface of a pocket adjacent to the first pocket is the same for each pairing of adjacent pockets in the base body.

In a particularly preferred embodiment, the angle between the radial line extending along the end face of the first end of the base body and the radial line passing through the center of the surface of the pocket adjacent to the first end is equal to the angle
between this line running radially and through the center of the surface of the first pocket adjacent to the first end
and a line running radially and through the center of the surface of the next pocket adjacent to the first pocket.

In a particularly preferred embodiment, the angle between the radial line extending along the end surface of the second end of the base body and the radial line passing through the center of the surface of the pocket adjacent to the second end is equal to the angle
between this line running radially and through the center of the surface of the last pocket adjacent to the second end
and a line running radially and through the center of the area of the penultimate pocket adjacent to the last pocket.

Embodiments are possible in which the pockets are irregularly distributed over the base body. An irregular distribution of pockets over the base body is understood to be a distribution in which, for at least two pairs of adjacent pockets, the angle
between a line running radially and through the center of the surface of a first pocket
and a line extending radially and through the center of the surface of a pocket adjacent to the first pocket different from the angle
between a line running radially and through the center of the surface of another pocket
and a line running radially and through the center of the surface of a pocket adjacent to the further pocket

Embodiments are possible in which the pockets are round or elliptical or rectangular in cross-section. In a preferred embodiment, however, the pockets are arched. In a preferred embodiment, the center of the arc along which the arched pocket extends is the center of the ring base body.

In a preferred embodiment, a pocket includes a first pocket end and a second pocket end circumferentially opposite the first pocket end. In a preferred embodiment, the first pocket end and/or the second pocket end is formed by a boundary surface extending in a radially extending plane. In an alternative embodiment, the first pocket end and/or the second pocket end is semicircular or circular sectional or polygonal, for example arrow-shaped.

In a preferred embodiment, a pocket of the base body has an inner edge that bounds the pocket on the side closer to the center of the ring base body. In a preferred embodiment, the inner edge is arched. In particular, the inner edge preferably runs in an arc around the center of the ring base body.

In a preferred embodiment, a pocket of the base body has an outer edge that bounds the pocket on the side further from the center of the ring base body. In a preferred embodiment, the outer edge is arched. In particular, the outer edge preferably runs in an arc around the center of the ring base body.

In a preferred embodiment, a pocket of the base body has a maximum width, where maximum width is understood to be the maximum distance in the radial direction between the inner edge and the outer edge of the pocket. In a preferred embodiment, the maximum width of the pocket is 50%, more preferably 60%, even more preferably 70%, even more preferably 80% of the radial width of the retaining ring at the location of the maximum width of the pocket.

In a preferred embodiment, the total area of the pockets, which corresponds to the area of the pocket present, insofar as only one pocket is present, or corresponds to the sum of the areas of the pockets present, corresponds to at least 10%, in particular preferably 20%, even more preferably 30%, even more preferably 40%, even more preferably 50% of the total area of the base body, the total area of the base body corresponding to the area bounded by the peripheral edge of the base body. The total area of the base body is thus the area bounded by the outer edge and the inner edge of the base body and any edges of the respective ends of the base body, without subtracting from this area the area of any mounting holes or the area of any pockets.

In a preferred embodiment, a pocket is located in the range between 10° and 90° and a pocket is located in the range between 350° and 270° when the center of the opening is taken as the 0° position. A pocket located closer to the end of a base body than to the part of the base body opposite the opening helps to improve the roundness of the retaining ring. An internal pocket located in the area of the base body opposite the opening helps balance the retaining ring in particular.

In a preferred embodiment, none of the pockets present are located in the range between 125° and 235° when the center of the opening is taken as the 0° position. Complementarily or alternatively, in a preferred embodiment, no pocket is arranged in the range between 10° and 90° and/or in the range between 350° and 270° when the center of the opening is taken as the 0° position.

In a preferred embodiment, the outer edge of the base body is continuous in the remaining area. In the remaining areas, in particular, preferably no projections are provided on the outer edge. In a preferred embodiment, the inner edge of the base body is continuous in the remaining area. In the remaining areas, in particular, preferably no projections are provided on the inner edge.

In a preferred embodiment, several of the pockets present, more preferably the majority of the pockets present, even more preferably all of the pockets present are of the same design with respect to their shape, wherein embodiments are conceivable in which the shape of a first pocket corresponds to the shape of a second pocket, but the first pocket is designed to be smaller than the second pocket with respect to its size. In a preferred embodiment several of the pockets present, more preferably the majority of the pockets present, even more preferably all the pockets are of the same design with respect to their size, this being understood to mean the area which the pocket occupies; however, embodiments are also conceivable in which the pockets are of the same size but are of different design with respect to their shape. In a particularly preferred embodiment, several of the pockets are present, more preferably the majority of the pockets are present, even more preferably all of the pockets present are of the same design both in terms of their size and in terms of their shape.

In a preferred embodiment, the outer edge of the base body is part-circular in shape and has a diameter of more than 55 mm, preferably more than 100 mm, more preferably more than 250 mm, and most preferably more than 400 mm. In a preferred embodiment, the inner edge of the base body is part-circular in shape and has a diameter of more than 55 mm, preferably more than 100 mm, more preferably more than 250 mm, and most preferably more than 400 mm.

In a preferred embodiment, the retaining ring is made of metal, preferably tempered steel or spring steel. However, embodiments in which the retaining ring is made of plastic are also conceivable. In a preferred embodiment, however, the retaining ring is not made of plastic.

In a preferred embodiment, the retaining ring according to the invention is used for wind turbines on trucks, agricultural machinery and construction vehicles, or industrial trucks or conveyor belts.

The shaft according to the invention has a circumferential groove and a retaining ring according to the invention arranged in the groove. The term “shaft” in the context of this description of the invention also includes an axle.

The component according to the invention has a bore and a groove running around in the bore, as well as a retaining ring according to the invention arranged in the groove.

### BRIEF DESCRIPTION OF THE DRAWINGS

In the following, the invention is explained more closely with the aid of drawings showing merely realizations. Shown are:

FIG. 1 a top view of a retaining ring according to the invention in accordance with a first embodiment;

FIG. 2 a top view of a retaining ring according to the invention in accordance with a second embodiment;

FIG. 3 a top view of a retaining ring according to the invention in accordance with a third embodiment;

FIG. 4 a top view embodiment; of a device according to the invention according to a fourth embodiment;

FIG. 5 a top view embodiment; of a device according to the invention according to a fifth embodiment;

FIG. 6 a top view embodiment; of a device according to the invention according to a sixth embodiment;

FIG. 7 a top view of embodiment and a device according to the invention according to a seventh embodiment;

FIG. 8 a top view embodiment. of a device according to the invention according to an eighth embodiment;

### DETAILED DESCRIPTION

The retaining rings 1 shown in FIGS. 1 to 8 each have a base body 2. The base body 2 is circular except for an opening 3 which interrupts it. The opening 3 interrupting the ring shape is bounded on a first side by an end face 4 of a first end 5 of the base body and on a second side opposite the first side by an end face 6 of a second end 7 of the base body 2.

In the embodiments according to FIGS. 1 to 4 and FIGS. 6 to 8, a mounting hole 8 is provided in the first end 5 of the base body 2. A mounting hole 9 is also provided in the second end 7 of the base body 2.

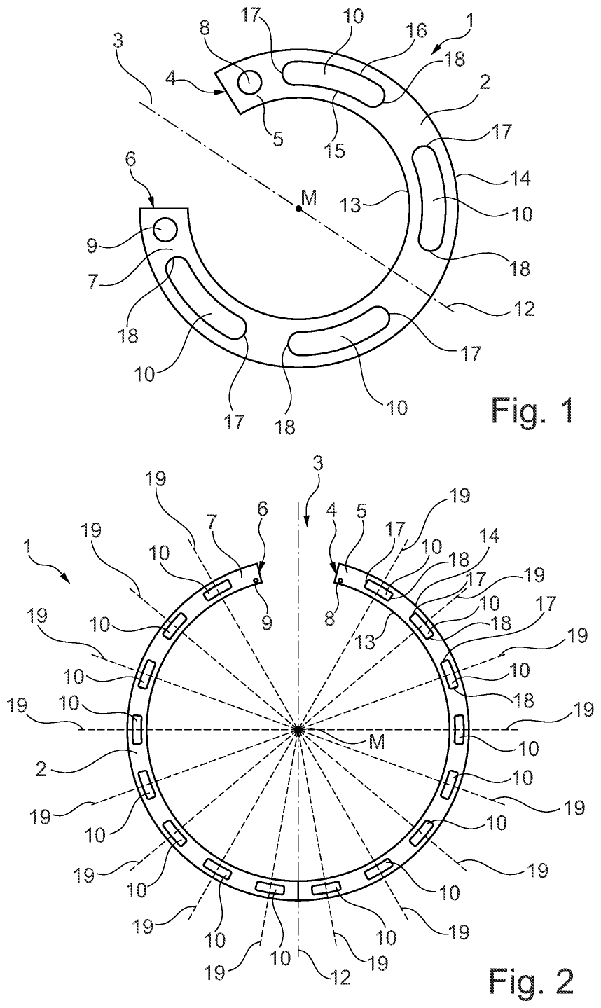

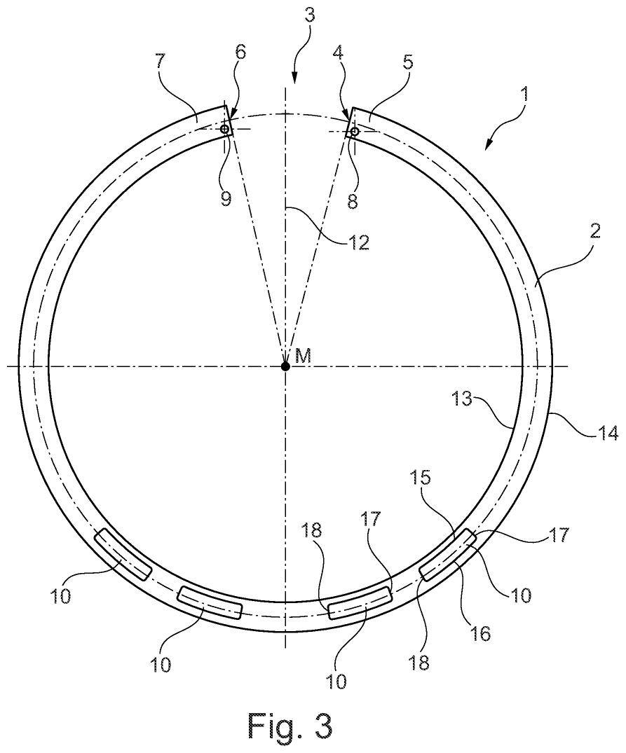

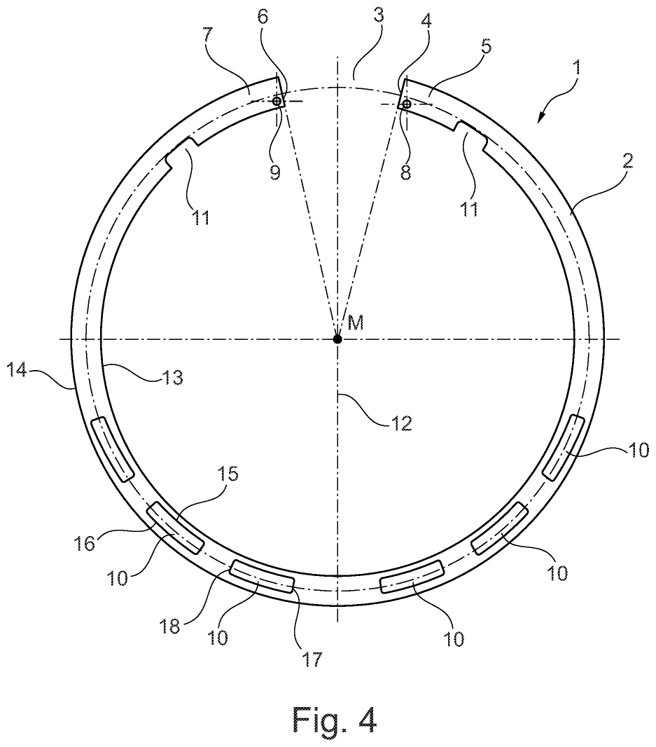

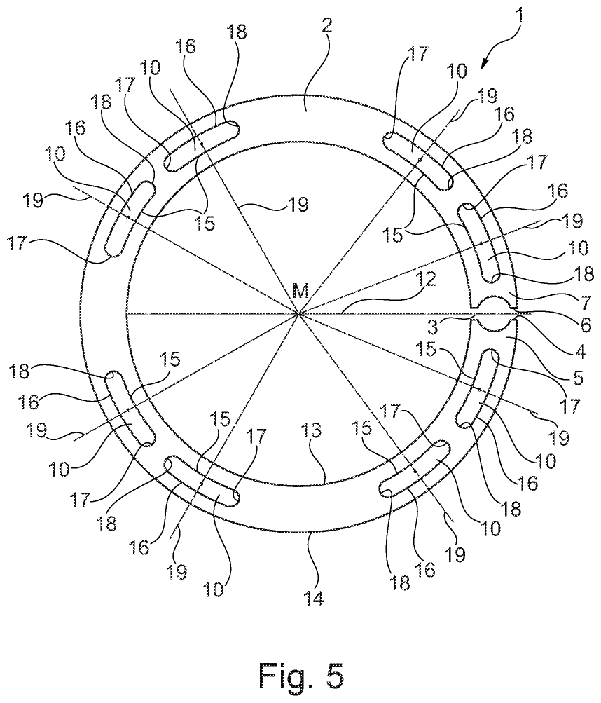

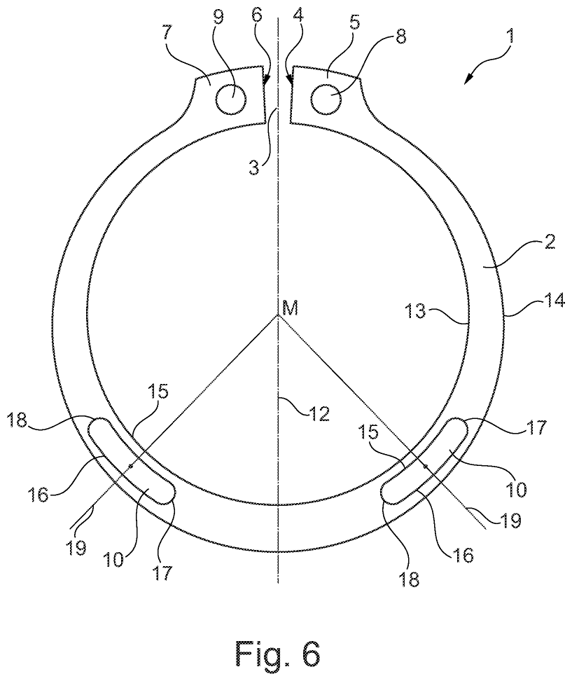

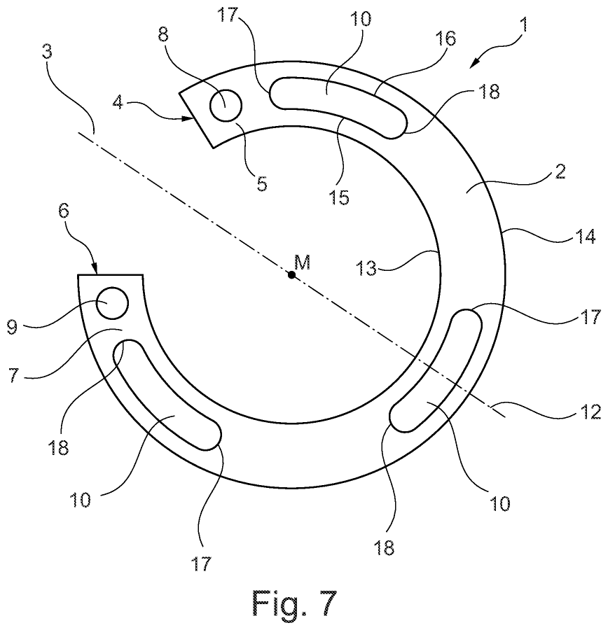

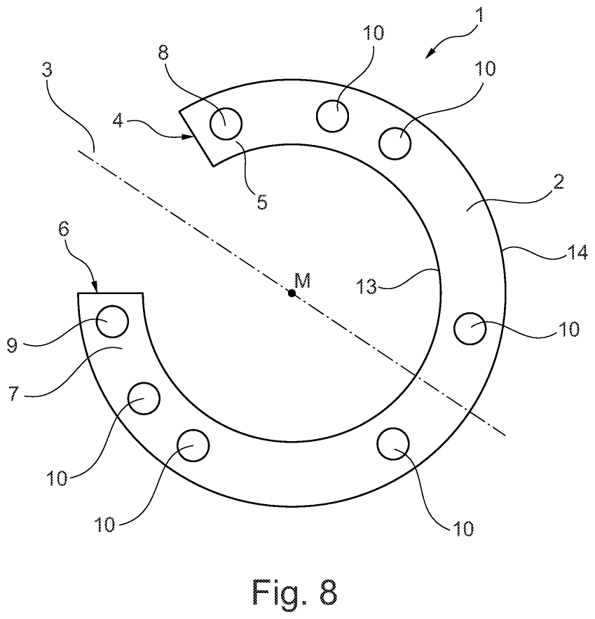

In the embodiment shown in FIG. 1, the base body 2 has four pockets 10. In the embodiment of FIG. 2, the base body 2 has sixteen pockets 10. In the embodiment shown in FIG. 3, the base body 2 has four pockets. In the embodiment of FIG. 4, the base body 2 has six pockets and two open pockets 11. In the embodiment according to FIG. 5, the base body 2 has eight pockets 10. In the embodiment shown in FIG. 6, the base body 2 has two pockets 10. In the embodiment shown in FIG. 7, the base body 2 has three pockets 10. In the embodiment shown in FIG. 8, the base body 2 has six pockets 10.

The retaining rings 1 according to the embodiments of FIGS. 1 to 8 are designed with mirror symmetry with respect to a plane 12 running centrally through the opening 3.

The pockets 10 in the embodiments according to FIGS. 1 to 7 are designed as an arched pocket 10. In this regard, the respective pocket 10 has a first pocket end 17 and a second pocket end 18 opposite the first pocket end 17 in the circumferential direction. In the embodiment of FIGS. 2, 3, 4, the first pocket end 17 and the second pocket end 18 are formed by a boundary surface extending in a radially extending plane. In the embodiment of FIGS. 1, 5, 6 and 7, the first pocket end 17 and the second pocket end 18 are semicircular.

In the embodiment according to FIG. 1, two pockets 10 are arranged in the range between 90° and 270° when the center of the opening 3 is taken as the 0° position. Furthermore, a pocket 10 in the range between 10° and 90° and a pocket 10 in the range between 350° and 270° are arranged there, if the center of the opening 3 is taken as the 0° position. In the 180° position is not located in any pocket.

In the embodiment of FIG. 2, the pockets 10 are distributed regularly around the circumference of the base body 2. The angle
between a line 19 extending radially and through the center of the surface of a first pocket 10
and a line 19 extending radially and through the center of the surface of a pocket 10 adjacent to the first pocket 10 is the same for each pairing of adjacent pockets 10 in the base body 2.

In the embodiments of FIGS. 1 to 8, all pockets 10 present are identical in size and shape.

The base body 2 has an inner edge 13 and an outer edge 14. The base body 2 has a center point M.

In FIGS. 1 to 7, the respective pockets 10 of the base body 2 have an inner edge 15, which closes the respective pocket 10 at the point corresponding to the center M closer side is limited. The inner edge 15 is arched and extends arched around the center M of the ring base body 2. Furthermore, the respective pocket 10 of the base body has an outer edge 16 which bounds the respective pocket 10 on the side furthest from the center point M. The outer edge 16 runs in an arc around the center point M of the ring base body 2.

FIG. 5 shows an embodiment in which the end face of the first end lies only partially in a plane and has a semicircular recess provided centrally in place of a mounting hole, and the end face of the second end lies only partially in a plane and has a semicircular recess provided centrally in place of a mounting hole.

FIG. 6 shows an embodiment in which the first end and the second end are designed as a so-called tab or as so-called ears, i.e. as a projection to the remaining area of the base body.

In the embodiment shown in FIG. 7, a pocket 10 is located in the range between 125° and 235° when the center of the opening 3 is taken as the 0° position. Furthermore, a pocket 10 in the range between 10° and 90° and a pocket 10 in the range between 350° and 270° are arranged there, if the center of the opening 3 is taken as the 0° position.

FIG. 8 shows an embodiment in which the six pockets 10 are circular.

In the embodiments of FIGS. 1 to 8, the base body 2 is rectangular in cross section.

1.-12. (canceled)

13. A retaining ring comprising:
a base body which is circular except for an opening interrupting said base body;
wherein the opening interrupting the ring shape is bounded on a first side by an end face of a first end of the base body and on a second side, opposite the first side, by an end face of a second end of the base body; and
wherein at least one closed pocket is disposed in the base body.

14. The retaining ring of claim 13, further comprising a first mounting hole disposed in the first end of the base body, and a second mounting hole disposed in the second end of the base body.

15. The retaining ring of claim 13, wherein at least two closed pockets are disposed in the base body.

16. The retaining ring of claim 15, wherein said base body is mirror-symmetrical with respect to a plane running centrally through the opening.

17. The retaining ring of claim 13, wherein the at least one closed pocket is curved.

18. The retaining ring of claim 13, wherein a total closed pocket area defined as the sum of the areas of each said at least one closed pocket is at least 10% of the total area of the base body, and wherein the total area of the base body corresponds to the area bounded by the outer contour of the base body.

19. The retaining ring of claim 13, wherein a closed pocket is located in the range between 125° and 235° when the center of the opening is taken as the 0° position.

20. The retaining ring of claim 13, wherein, when the center of the opening is taken as 0° position, a closed pocket is located in the range between 10° and 90°.

21. The retaining ring of claim 13, wherein, when the center of the opening is taken as 0° position, a closed pocket is located in the range between 350° and 270°.

22. The retaining ring of claim 13, wherein, when the center of the opening is taken as 0° position, a closed pocket is located in the range between 10° and 90° and another closed pocket is located in the range between 350° and 270°.

23. The retaining ring of claim 13, wherein the at least one closed pocket comprises a plurality of closed pockets, a majority of which have the same size and/or shape.

24. The retaining ring of claim 23, wherein all of the closed pockets have the same size and/or the same shape.

25. The retaining ring of claim 13, wherein the first end and/or second end of the base body is adapted so as to be devoid of mounting holes.

26. The retaining ring of claim 13, wherein a plurality of closed pockets are disposed in said base body, and wherein said base body is minor-symmetrical with respect to a plane running centrally through the opening.

27. A shaft having a circumferential groove and a retaining ring disposed in the groove, wherein the retaining ring comprises a base body which is ring shaped except for an opening interrupting said base body, wherein the opening interrupting the ring shape is bounded on a first side by an end face of a first end of the base body and on a second side, opposite the first side, by an end face of a second end of the base body, and wherein at least one closed pocket is disposed in the base body.

28. The shaft of claim 27, wherein a first mounting hole is disposed in the first end of the base body, and a second mounting hole is disposed in the second end of the base body.

29. The shaft of claim 28, wherein a plurality of closed pockets are disposed in said base body, and wherein said base body is minor-symmetrical with respect to a plane running centrally through the opening.

30. A component having a bore and a groove running around in the bore and a retaining ring arranged in the groove, wherein the retaining ring comprises a base body which is ring shaped except for an opening interrupting said base body, wherein the opening interrupting the ring shape is bounded on a first side by an end face of a first end of the base body and on a second side, opposite the first side, by an end face of a second end of the base body, and wherein at least one closed pocket is disposed in the base body.

31. The component of claim 30, wherein a first mounting hole is disposed in the first end of the base body, and a second mounting hole is disposed in the second end of the base body.

32. The shaft of claim 31, wherein a plurality of closed pockets are disposed in said base body, and wherein said base body is mirror-symmetrical with respect to a plane running centrally through the opening.
